(19) United States
(12) Patent Application Publication
(10) Pub. No.: US 2024/0193836 A1
(43) Pub. Date: Jun. 13, 2024

(54) METHOD AND SYSTEM FOR CUSTOMIZATION OF A VIRTUAL AVATAR

(71) Applicants: Sony Interactive Entertainment Europe Limited, London (GB); Sony Interactive Entertainment LLC, San Mateo, CA (US)

(72) Inventors: Lloyd Preston STEMPLE, London (GB); Aron Giuseppe VISCIGLIA, London (GB); Daisuke KAWAMURA, London (GB); Ramanath BHAT, London (GB); Pedro Federico Quijada LEYTON, London (GB); David Erwan Damien UBERTI, London (GB)

(73) Assignees: Sony Interactive Entertainment Europe Limited, London (GB); Sony Interactive Entertainment LLC, San Mateo, CA (US)

(21) Appl. No.: 18/531,860

(22) Filed: Dec. 7, 2023

(30) Foreign Application Priority Data
Dec. 8, 2022 (GB) 2218464.2

(51) Int. Cl. G06T 13/40; G06T 13/20; G06V 40/16

(52) U.S. Cl. CPC G06T 13/40; G06T 13/205; G06V 40/161; G06V 40/168

(57) ABSTRACT

A computer-implemented system and method for real-time customization of a virtual avatar, comprising providing a virtual avatar associated with a user, receiving an image of the user and at least a portion of their surroundings, applying a facial detection algorithm to detect the user's face in the image, extracting a region of interest from the image, the region of interest including the user's face, providing the region of interest to a data model, processing the region of interest, by the data model, and using feature recognition to determine whether the region of interest comprises a feature from a set of predefined features. In response to determining that the region of interest comprises a feature from a set of predefined features, the appearance of the virtual avatar is updated.

### CROSS-REFERENCE TO RELATED APPLICATIONS

The present application claims priority from British Patent Application No. 2218464.2 filed Dec. 8, 2022, the contents of which are incorporated herein by reference in its entirety.

### BACKGROUND

The present specification relates to computer-implemented systems and methods for customization of a virtual avatar.

A virtual avatar is a graphical representation of a user, or a user's chosen character, on a digital platform. A virtual avatar can have a two-dimensional form (e.g. an image or icon) or a three-dimensional form (e.g. a character in a 3D computer game).

The use of a virtual avatar rather than an image or video of the user can allow a user to maintain some anonymity in the digital world. However, in some situations it is preferable for the virtual avatar to be at least partially personalised by the user. Thus, the virtual avatar may be representative, visually or otherwise, of the user. If multiple users have the same avatar, it can be beneficial to distinguish the two avatars from each other.

The use of virtual avatars is not limited to gaming, as increasingly virtual avatars are being used to represent users in digital events, meetings, and in interactive training exercises.

### SUMMARY

Aspects of the present disclosure are set out in the accompanying independent and dependent claims. Combinations of features from the dependent claims may be combined with features of the independent claims as appropriate and not merely as explicitly set out in the claims.

In a first aspect of the present disclosure, there is provided a computer-implemented method for real-time customization of a virtual avatar, comprising: providing a virtual avatar associated with a user, receiving input data, providing at least a portion of the input data to a data model, processing the input data by the data model to determine whether the input data comprises a feature from a set of predefined features, and in response to determining that the input data comprises a feature from a set of predefined features, updating the appearance of the virtual avatar.

In prior art systems, although the appearance of a virtual avatar may be at least partially customizable, this generally requires the user to manually update the appearance of the virtual avatar in a set-up process. For example, the user may have multiple options to manually select to choose the virtual avatar's hair style, skin tone, clothing, and so on. In the present disclosure, there is an automatic updating of the appearance of the virtual avatar which does not require a manual input from the user.

The input data may comprise audio data.

Optionally, the audio data may be captured by a microphone associated with the user.

Optionally, the audio data may be received from an electronic device or a computing device.

The input audio data may be processed to determine whether the audio data includes music.

Optionally, the data model may be configured to use audio recognition techniques when processing the input audio data.

In response to determining that the audio data includes music, the method may include determining at least one property of the music.

The appearance of the virtual avatar may be updated in response to the determined at least one property of the music.

The input data may comprise image data.

It will be appreciated that in some embodiments a first data model may be configured to received input audio data, and a second data model may be configured to receive input image data.

In some embodiments, the same data model may process both input audio data and input image data.

The image data may comprise an image of the user and at least a portion of their surroundings.

The data model may be configured to use object recognition or feature recognition techniques when processing the input image data.

In an embodiment, there is provided a computer-implemented method for real-time customization of a virtual avatar, comprising: providing a virtual avatar associated with a user, receiving an image of the user and at least a portion of their surroundings, applying a facial detection algorithm to detect the user's face in the image, extracting a region of interest from the image, the region of interest including the user's face, providing the region of interest to a data model, processing the region of interest, by the data model, and using feature recognition to determine whether the region of interest comprises a feature from a set of predefined features, and in response to determining that the region of interest comprises a feature from a set of predefined features, updating the appearance of the virtual avatar.

In the present disclosure, the terms ‘object recognition’ and ‘feature recognition’ may be used interchangeably.

Thus, the present disclosure also provides a more efficient and accurate method for processing the input data from the user. In the present disclosure, the input image may be of the user and at least a portion of their surroundings. In some embodiments this input image is captured using a webcam or other camera coupled to an electronic device. The image data that is generally of interest to the data model is of the user and the area immediately surrounding the user. As such, this input image may contain a lot of data that is not ‘of interest’ to the data model, particularly if the user is quite far away from the camera. Processing all of this input data increases processing time and decreases efficiency. In the present disclosure, this is addressed by detecting the user's face in the input image and extracting a region of interest, the region of interest including the user's face. Accordingly, this reduces the amount of data input to the data model and improves the accuracy and efficiency of the feature recognition process.

Optionally, the facial detection algorithm may be a Haar Cascade algorithm.

Optionally, the step of applying the facial detection algorithm to detect the user's face in the image may be carried out by the, or a, data model.

Optionally, if more than one face is detected in the image then the method may comprise identifying the user's face. This may be done using feature recognition and/or facial recognition techniques. This may be done by the data model. The data model may be trained using a plurality of images of the user's face.

In some embodiments, the step of extracting a region of interest from the image may be carried out by the, or a, data model.

In some embodiments, the region of interest may comprise two or more features from the set of predefined features.

Optionally, more than one aspect of the appearance of the virtual avatar may be updated.

In some embodiments, a notification may be output to the user asking if they want to update the appearance of the virtual avatar (before the update is applied). It will be appreciated that the user may prefer to not update the appearance of the virtual avatar.

Optionally, the set of predefined features includes, but is not limited to: a plurality of facial features or body features; and/or a plurality of accessories that may be worn on the user's face, head or body.

The plurality of facial features or body features may include one or more of, but is not limited to: hair colour; hair length; hair style; facial hair; ear type; nose type; eye type; tattoos; birthmarks; and/or skin tone.

The plurality of accessories may include one or more of, but is not limited to: eyewear (such as spectacles and/or sunglasses); headwear; jewellery; clothes and/or other worn accessories.

Optionally, updating the appearance of the virtual avatar comprises applying the feature to the virtual avatar.

In some embodiments, the appearance of the virtual avatar may be update to include a feature which is similar to or representative of the feature detected by the data model. This may be limited by the options available for the virtual avatar.

In some embodiments, updating the appearance of the virtual avatar comprises reviewing an image directory comprising a plurality of image elements to identify an image element that is similar to or representative of the feature. The image element may then be applied to the virtual avatar, or the virtual avatar may be updated to include the image element.

Optionally, the image directory is associated with the virtual avatar.

Optionally, each feature of the set of predefined features has an associated label. Each image element may have an associated label. Reviewing the image directory to identify the image element that is representative of the feature may comprise reviewing the image directory to identify an image element having a label that is the same as, or is closest to, or is associated with, the label of the feature.

Optionally, the region of interest is centred on the user's face and has a predefined area. The predefined area may vary depending on the particular application.

In some embodiments, the predefined area may be set to capture the user's head and shoulders. The predefined area may include the area immediately surrounding the user's face, such that any accessories worn on the users face or head may be included in the region of interest.

Prior to providing the region of interest to the data model, the method may include scaling the region of interest to a predetermined size. The predetermined size may be set by the data model.

In some embodiments, the method includes assigning, by the data model, a confidence value to the determined feature.

Optionally, the appearance of the virtual avatar is only updated if the confidence value exceeds a predetermined threshold.

In some embodiments, audio input data may be used to update the appearance of the virtual avatar.

The method may further comprise receiving input audio data. In some embodiments, the audio data may be captured by a microphone associated with the user.

The input audio data may be processed to determine whether the audio data includes music. In some embodiments, the audio data may be provided to the, or a, data model for processing. Optionally, the data model may be configured to use audio recognition techniques.

In response to determining that the audio data includes music, the method may include determining at least one property of the music. This step may be carried out by the data model.

The appearance of the virtual avatar may be updated in response to the determined at least one property of the music.

In some embodiments, the method may include determining whether the music (or audio data) comprises a property of a predetermined set of properties.

Optionally, the method may include receiving input data identifying a music track that the user is listening to. Thus, rather than detecting the music from input audio data, the method may include directly receiving information identifying a music track that the user is listening to.

In some embodiments, the computer-implemented system may be in communication with at least one user electronic device, such as a mobile phone, PC, tablet, earphones or headphones, gaming console. The user electronic device may provide the audio data, or the input data identifying a music track that the user is listening to, to a processor or to the data model.

The method may include determining or receiving at least one property of the music track.

The method may include updating the appearance of the virtual avatar in response to the determined at least one property of the music track.

Optionally, the least one property of the music includes one or more of, but is not limited to: a volume; a tempo; a genre; an artist; a play count; and/or a duration.

Optionally, the at least one property may comprise any kind of metadata related to the music or audio data. For example, the at least one property may comprise lyrics or album art.

Optionally, the appearance of the virtual avatar may only be updated in response to the determined at least one property of the music track if at least one criteria or threshold is satisfied.

Optionally, updating the appearance of the virtual avatar in response to the determined at least one property comprises one or more of, but is not limited to: changing a colour or design of at least one accessory worn by the virtual avatar; adding or removing at least one accessory worn by the virtual avatar; and/or applying a skin from a plurality of predefined skins to the virtual avatar.

Optionally, the data model comprises an artificial neural network (ANN).

Optionally, the ANN comprises a convolutional neural network (CNN).

In a second aspect of the present disclosure, there is provided a system comprising one or more processors configured to implement the method as recited in any embodiment or example of the first aspect of the disclosure.

In some embodiments, the system may be a computing device.

In a third aspect, there is provided a non-transitory machine-readable medium having stored thereon a set of instructions, which if performed by one or more processors, cause the one or more processors to implement the method as recited above in any embodiment or example of the first aspect of the disclosure.

### BRIEF DESCRIPTION OF THE DRAWINGS

Embodiments of this disclosure will be described hereinafter, by way of example only, with reference to the accompanying drawings in which like reference signs relate to like elements and in which:

FIG. 1 is a flowchart showing a method according to an embodiment of this disclosure;

FIG. 2 is a flowchart showing a method according to another embodiment of this disclosure;

FIG. 3A shows an example of an input image according to this disclosure;

FIG. 3B shows an enlarged version of the region of interest in FIG. 3B;

FIG. 4 is a flowchart showing a method according to another embodiment of this disclosure;

FIG. 5 is a schematic diagram illustrating a cloud gaming system that may be used in accordance with this disclosure; and

FIG. 6 is a block diagram of one example implementation of a computing device.

### DETAILED DESCRIPTION

Embodiments of this disclosure are described in the following with reference to the accompanying drawings.

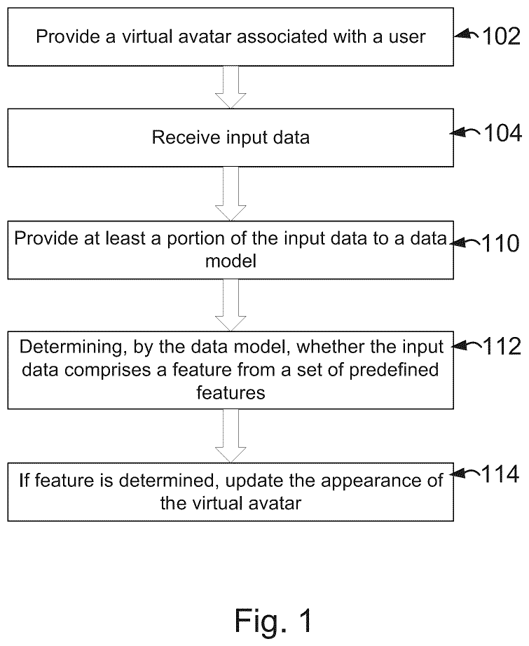

FIG. 1 is a flowchart illustrating a computer-implemented method according to an embodiment of the present disclosure.

At step 102 the method comprises providing a virtual avatar associated with a user. The virtual avatar may be output on a display screen of a computing device.

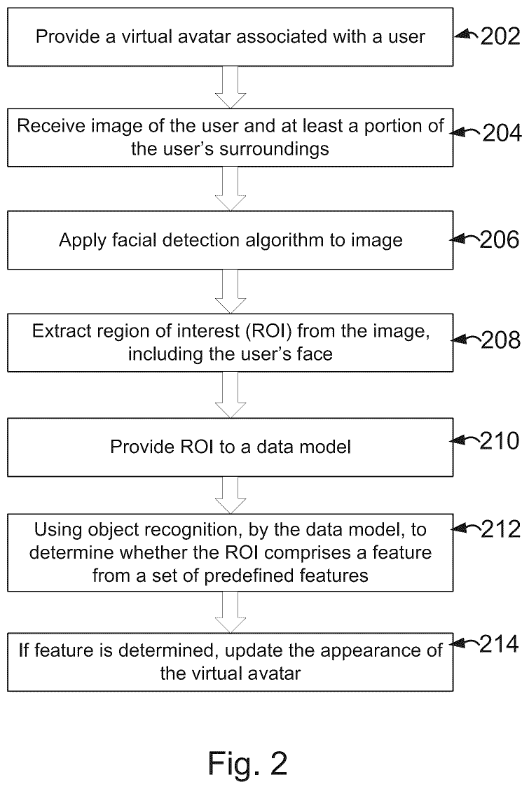

At step 104 the method comprises receiving input data. The input data may include audio data and/or image data, as described in more detail in connection with FIGS. 2 to 4. The input data may be received from one or more input sources.

At least a portion of the input data is then provided to a data model (step 110). In some embodiments, a first data model is provided to process input audio data, and a second data model is configured to process input image data. In some embodiments, a single data model can process both input audio data and input image data.

In some embodiments the method is implemented by a processing resource. The processing resource may comprise, or be in communication with, the data model.

The data model may comprise an artificial neural network (ANN). In some embodiments, the ANN may comprise a convolutional neural network (CNN).

ANNs (including CNNs) are computational models inspired by biological neural networks and are used to approximate functions that are generally unknown. ANNs can be hardware-based (neurons are represented by physical components) or software-based (computer models) and can use a variety of topologies and learning algorithms. ANNs can be configured to approximate and derive functions without a prior knowledge of a task that is to be performed and instead, they evolve their own set of relevant characteristics from learning material that they process. A convolutional neural network (CNN) employs the mathematical operation of convolution in at least one of their layers and are widely used for image mapping and classification applications.

In some examples, ANNs can have three layers that are interconnected. The first layer usually consists of input neurons. These input neurons send data on to the second layer, referred to a hidden layer which implements a function and which in turn sends output neurons to the third layer. With respect to the number of neurons in the input layer, this may be based on training data or reference data relating to traits of an avatar provided to train the ANN for detecting similar traits and modifying the avatar accordingly.

The second or hidden layer in a neural network implements one or more functions. There may be a plurality of hidden layers in the ANN. For example, the function or functions may each compute a linear transformation of the previous layer or compute logical functions. For instance, considering that an input vector can be represented as x, the hidden layer functions as h and the output as y, then the ANN may be understood as implementing a function of using the second or hidden layer that maps from x to h and another function g that maps from h to y. So, the hidden layer's activation is f(x) and the output of the network is g(f(x)).

To train the data model to detect a feature of a predetermined set of features from the input data, the data model may be provided with a plurality of training media files. The training media files may comprise images and/or audio files. For example, the training images may comprise images of people having different features from the predetermined set of features.

The training media files may in some embodiments be provided in the form of a data file or data structure or a database that includes annotations or description associated with a given training media file, such as: a training input including a label or an annotation for a feature of the predetermined set of features associated with a given region of the training media file; and a training output identifying the specific feature of the predetermined set of features that is associated with the label or annotation.

It will be appreciated that there are multiple methods by which a data model may be trained to use feature (or object) and/or audio recognition to determine features from input image and/or audio data.

At step 112 the data model determines whether the input data comprises a feature from a predefined set of features. This may be done using object or feature recognition, or audio recognition.

If a feature from the predefined set of features is detected in the input data, then the method comprises updating the appearance of the virtual avatar (step 114).

In some embodiments, where the feature is a visual feature, step 114 comprises applying the detected features to the virtual avatar, or updating the virtual avatar to include the feature.

In some embodiments, the predefined set of features may include audio features, such as (but not limited to) music genre types, volume, tempo, etc. The audio features may have associated visual outputs or conditions. For example, if the data model detects that the user is listening to a country music song, the method may include updating the virtual avatar to wear a cowboy hat.

In some embodiments, the input data received at step 104 may comprise audio data captured by a microphone. At step 112 the data model may process the audio data to determine whether the audio data includes a voice, or a particular user's voice. This may be done using audio recognition techniques, wherein the data model may be trained using stored audio data of the particular user's voice.

The data model may be configured to determine the pitch and/or tone of a user's voice in the input audio data. Based on this determination, the appearance of the virtual avatar may be updated (step 114).

In some embodiments, the input audio data may comprise environmental audio data captured from the user's environment. The data model may be configured to determine one or more properties of the user's environment by processing the input audio data. At step 114, the appearance of the virtual avatar, and/or the virtual environment, may be updated based on this determination.

In one non-limiting example, if the environmental audio suggests that the user is in a quiet environment then the virtual avatar may be updated to have a calm emotion or pose, and/or the virtual environment may be updated to reflect a calm environment. In one non-limiting example, if the input audio data is determined to include a dog barking in the background, the virtual avatar may be updated to have a dog provided next to it. In one non-limiting example, the input audio data may include weather audio, such as a thunderstorm.

The detected weather may be reflected in the virtual environment and/or the appearance of the virtual avatar. In the example of a thunderstorm, the virtual avatar may be updated to hold an umbrella, or wear a raincoat, or look scared.

In one non-limiting example, if the data model processing the environmental audio data detects a doorbell ring, the virtual avatar may be updated to react to this (for example a suitable pose or a emotion). An ‘away from keyboard’ status may also be prepared in anticipation of the user absence.

In some embodiments, the input audio data at step 104 may include audio of the user breathing. The data model may be configured to assess the breathing pattern of the user and update the appearance of the avatar accordingly. In one non-limiting example, if the data model determines that the user is tense based on the breathing audio data, then the expression and/or pose of the virtual avatar may be adjusted to reflect this tension.

In some embodiments, the data model can assess trends in the input audio data received over time and adjust the appearance of the avatar accordingly. In one non-limiting example, if the data model determines that the user frequently laughs, then the virtual avatar can be updated to have a slightly fixed smile or a happier expression. If the user tends to get frustrated and loud (e.g. at difficult times during a game) then the virtual avatar can have more of a frown. If there is no audio input for victory or success (or if this is unusual for the user) then the virtual avatar can be updated to have an unsurprised or fixed expression.

It will be appreciated that the input audio data can be processed in addition to input image data received, to provide additional sources for updating the appearance of the virtual avatar or the virtual environment.

FIG. 2 is a flowchart illustrating another computer-implemented method according to an embodiment of the present disclosure. Features which are common between FIGS. 1 and 2 have been numbered accordingly.

At step 202, the method comprises providing a virtual avatar associated with a user.

At step 204, the method comprises receiving an image of the user and at least a portion of the user's surroundings. The image is captured by a camera (such as a webcam).

At step 206, a facial detection algorithm is applied to the image to detect the location of the user's face within the image. The facial detection algorithm may be a Haar Cascade algorithm, although other algorithms may be used.

If a face is not detected in the image at step 206 then the image may be rejected and a new image may be received or processed. Optionally, the method may comprise adjusting a position, orientation or zoom of the camera if the user's face is not detected in the image.

If multiple faces are detected in the image at step 206, then the user's face is detected from the plurality of faces. This may be achieved using object or feature recognition and/or facial recognition. For example, this may be carried out by the data model, and the data model may be trained using a plurality of images of the user to recognize the user's face.

At step 208 the method then comprises extracting a region of interest (ROI) from the image. The ROI includes the user's face. It will be appreciated that the image received may contain a lot of data that is not relevant to the data model, for example the image may be of an entire room containing the user. By extracting the ROI this improves efficiency and accuracy of the processing by the data model, as only relevant information is provided to the data model.

In some embodiments, the ROI may be the head and shoulders of the user. In some embodiments, the ROI may be centered on the user's face and may have a predetermined area. In some embodiments, the ROI may be the whole of the user's body.

At step 210, the ROI is provided to the data model. This may be done via a wired or wireless communication channel.

The data model (which may comprise an ANN as discussed above) then uses object or feature recognition to determine whether the ROI comprises a feature from a predefined set of features (step 212).

In the embodiment shown in FIG. 2, the predefined set of features comprises visual features. The set of predefined features may include a plurality of facial features or body features and/or a plurality of accessories that may be worn on the user's face, head or body. Optionally, the plurality of facial features or body features include one or more of: hair colour; hair length; hair style; facial hair; ear type; nose type; eye type; tattoos; birthmarks; and/or skin tone.

Optionally, the plurality of accessories include one or more of: eyewear; headwear; jewellery; clothes and/or other worn accessories.

In step 214, the method comprises updating the appearance of the virtual avatar if it is determined in step 212 that a feature of the predefined set of features is present in the ROI.

In a non-limiting example, at step 212 the data model may be configured to process the ROI to determine whether the user is wearing a hat, or has blonde hair, or has facial hair. In some embodiments, the predefined set of features may include a plurality of facial hair types, such as a full beard, a 5 o'clock shadow, a goatee and/or a moustache. If the data model detects that the user does have a moustache, then at step 214 the method may include updating the virtual avatar to include a moustache. If the data model detects that the user does have blonde hair, then at step 214 the method may include updating the virtual avatar to also have blonde hair.

In some embodiments, step 214 may comprise reviewing an image directory to identify an image element that is associated with the feature detected in the ROI, or is closest to the feature detected in the ROI. The image directory may be specific to the virtual avatar.

In some embodiments, the image directory may be associated with the user. The user may build an image directory that can be used to update the visual appearance of one or more avatars.

In the above non-limiting example, step 214 may comprise reviewing an image directory to identify an image of a moustache (or a skin of the virtual avatar including a moustache).

Optionally, the predefined set of features may comprise a plurality of moustache types, such as (but not limited to) handlebar, pencil, Fu Manchu, etc. The data model may be configured to identify the particular type of moustache that the user has in the ROI. Step 214 may comprise applying that moustache type to the virtual avatar.

In some embodiments, other aspects of the appearance of the virtual avatar may be updated at step 214, instead of or in addition to applying the determined feature to the avatar. For example, the colour or type of clothes and/or accessories worn by the avatar may be changed based on the determined feature.

Optionally, step 214 may comprise generating a new image element (or skin) for the virtual avatar. The new image element (or skin) may be stored in an image directory for future use.

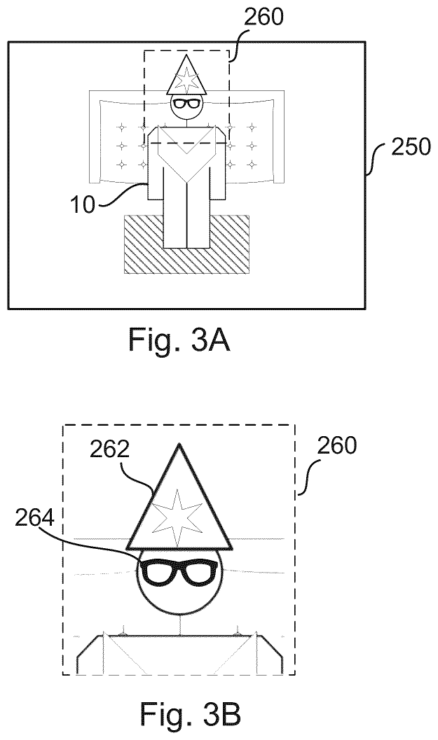

FIG. 3A shows an example input image 250 received from a camera, the image 250 comprising a user 10 and a portion of their surroundings, including a sofa and a rug. The area labelled 260 in FIG. 3A is an example region of interest (ROI) extracted from the input image following the application of a facial detection algorithm to identify the user's face. The ROI 260 is shown in more detail in FIG. 3B. A simplified representation of a user 10 is shown for the sake of convenience. It will be appreciated that FIGS. 3A and 3B are not drawn to scale.

In FIG. 3B the ROI 260 includes the head and shoulders of the user 10, but it will be appreciated that this can vary depending on the particular application. The remainder of the image data (i.e. everything except the ROI) is discarded or ignored.

The ROI 260 in FIG. 3B is optionally scaled to a predetermined size (e.g. N×M pixels) before being provided to the data model. The predetermined size may be determined by the data model (e.g. this may be based on how the data model is trained).

As shown in FIG. 3B, in this example the user 10 is wearing a hat 262 and spectacles (or glasses) 264. As mentioned above, FIG. 3B is a simplified representation of the real image data that would be presented to the data model. The data model is configured to process the ROI 260 and, using object or feature recognition, determine if the ROI 260 includes any features from a predefined set of features. In this example, the predefined set of features may include a hat and spectacles. The data model processing ROI 260 should therefore determine that the user 10 is wearing a hat and is wearing spectacles. The appearance of the virtual avatar associated with the user 10 (not shown) may then be updated to include a hat and/or spectacles.

Optionally, the predefined set of features may be more specific and include a variety of types of hat, such as (but not limited to) a wizard hat, a cap, a top hat, a beret, a beanie and/or a cowboy hat. In this example, the data model may determine that the user 10 is wearing a wizard hat, based on the shape of the hat and the star decoration. The appearance of the virtual avatar associated with the user 10 (not shown) may then be updated to a wizard theme or skin.

In some embodiments (not shown in the figures) the data model is configured to determine a confidence value for each feature that is detected in the ROI. In some embodiments, the data model may determine a confidence value for each feature of the predefined set of features, wherein the confidence value indicated how likely it is that the ROI includes said feature. The higher the confidence value is, the more confident the data model is that the ROI includes that feature.

Optionally, step 214 may include reviewing the output confidence values. In some embodiments, the appearance of the virtual avatar may only be updated in response to a given feature if the confidence value for said feature exceeds a predetermined threshold.

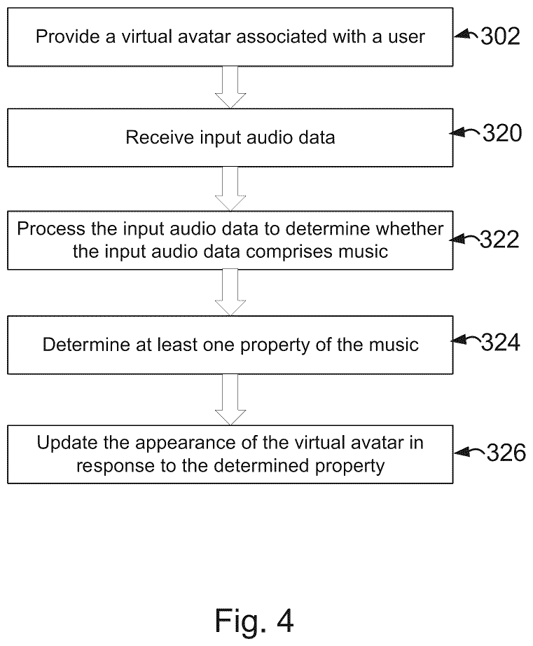

FIG. 4 is a flowchart illustrating another embodiment of a computer-implemented method according to the present disclosure. Steps 320 to 326 may be carried out in addition to steps 204 to 214 in FIG. 2.

At step 302 the method includes providing a virtual avatar associated with a user. At step 320 the method comprises receiving input audio data, or data related to audio data.

The input audio data may be captured by a microphone. The microphone may be provided in a user input device, such as a controller.

At step 322, the method comprises processing the input audio data to determine whether the input audio data comprises music. This may be done using audio recognition software/techniques. The processing may be carried out by a data model. This may be the same data model that is configured to process input image data, or a different data model.

The data model may be trained to recognize a plurality of audio waveform attributes, and associate these waveform attributes with one or more properties of the audio data.

At step 324, if the audio data is determined to comprise music, at least one property of the music is determined. In some non-limiting examples, the at least one property may comprise one or more of: a volume; a tempo; a genre; an artist; a duration and/or a play count. The at least one property may comprise any kind of metadata related to the audio data.

At step 326, the appearance of the virtual avatar is updated (i.e. changed or adjusted) in response to the determined at least one property of the music.

Optionally, at step 326 the appearance of the virtual avatar may only be updated in response to the determined at least one property if at least one criteria or threshold is satisfied. In one non-limiting example, the appearance of the virtual avatar may only be updated if the duration of the music exceeds a predetermined time period. In another non-limiting example, the appearance of the virtual avatar may only be updated if the volume of the music exceeds a predetermined threshold.

In some embodiments, step 320 may comprise receiving data related to audio data. Thus, the music track itself may not be received. For example, at step 320 data identifying one or more properties of a music track being listened to by the user may be received from an electronic device (such as a mobile phone, speaker, ear phones, etc.). In one non-limiting example, the method may comprise receiving a name of a music track being listened to by the user. The method may comprise determining a genre of the music track based on the name of the music track. The appearance of the virtual avatar may be updated based on the genre of the music track.

For example, if the user is determined to be listening to a heavy metal music track, the colours of the avatar's clothes and/or accessories may change to black. In another example, if the user is determined to be listening to a song by the band Kiss™, then black and white face-paint may be applied to the virtual avatar. Similarly, if the user is determined to be listening to a song from a Spider-Man™ video game, then the virtual avatar may be updated to include the Spider-Man™ logo, or wear a Spider-Man™ skin. It will be appreciated that some visual changes may be subject to copyright and/or trade mark permissions.

The changes to the visual appearance of the virtual avatar may be temporary (e.g. for the duration of the music track).

It will be appreciated that in other examples, audio data other than music may be processed to update the appearance of the avatar.

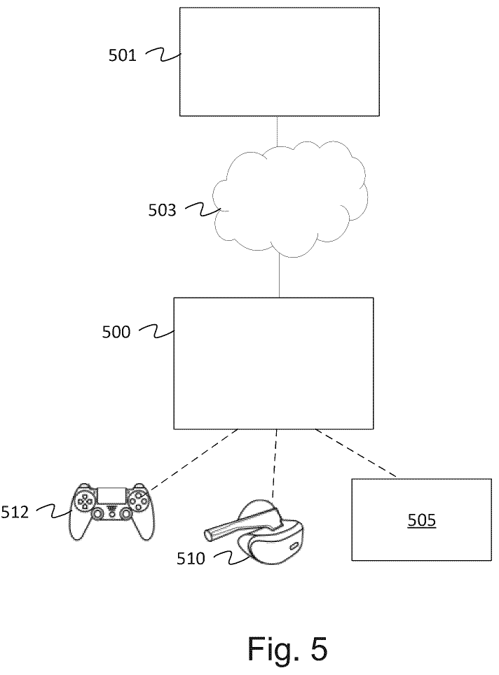

FIG. 5 shows a schematic illustration of a cloud gaming system in accordance with an embodiment of the present disclosure. In FIG. 5, the cloud gaming system is shown as comprising a server 501 that is in communication with a client device (or computing device) 500 via a communications network 503. The client device 500 may be in communication with the data model via the communications network 503.

In other embodiments, the system may not comprise one or both of the server 501 or the communication network 503. Instead, the client device 500 may comprise memory, at least one processor and the data model required to execute the method of the present disclosure. Alternatively, the client device 500 may receive a non-transitory computer readable memory comprising the instructions required to execute the method of the present disclosure.

The client device 500 may include, but is not limited to, a video game playing device (games console), a smart TV, a set-top box, a smartphone, laptop, personal computer (PC), USB-streaming device, etc. The client device 500 comprises, or is in communication with, at least one source configured to obtain input data from the user.

In this embodiment, the at least one source includes an extended reality display device (PS VR® headset) 510, an input device 112 (DualShock 4 ®), and a camera 505. It will be appreciated that the input sources are not limited to these examples, which are provided for illustrative purposes only. A different number of, and/or different types of input sources may be provided. The input sources may be in communication with the client device 500 via a wired or wireless connection.

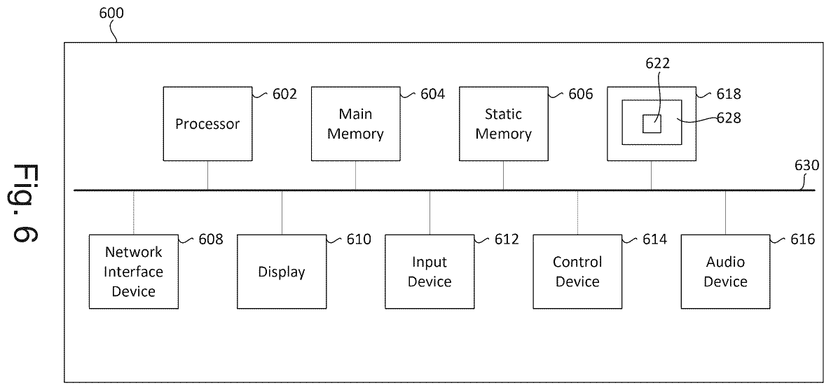

FIG. 6 illustrates a block diagram of one example implementation of a computing device 600 that can be used for implementing the method shown in FIGS. 1 to 4 and described throughout the detailed description. The computing device is associated with executable instructions for causing the computing device to perform any one or more of the methodologies discussed herein. The computing device 600 may operate in the capacity of the data model or one or more computing resources for implementing the data model for carrying out the methods of the present disclosure. In alternative implementations, the computing device 600 may be connected (e.g., networked) to other machines in a Local Area Network (LAN), an intranet, an extranet, or the Internet. Optionally, a plurality of such computing devices may be used. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a secondary memory (e.g., a data storage device 618), which communicate with each other via a bus 630.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 622) for performing the operations and steps discussed herein.

The computing device 600 may further include a network interface device 608. The computing device 600 also may include a video display unit 610 (e.g., a liquid crystal display (LCD) or a cathode ray tube (CRT)), an alphanumeric input device 612 (e.g., a keyboard or touchscreen), a cursor control device 614 (e.g., a mouse or touchscreen), and an audio device 616 (e.g., a speaker).

The data storage device 618 may include one or more machine-readable storage media (or more specifically one or more non-transitory computer-readable storage media) 628 on which is stored one or more sets of instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing”, “calculating”, “computing,” “identifying”, “detecting”, “establishing”, “training”, “determining”, “storing”, “generating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Accordingly, there has been described computer-implemented systems and methods for real-time customization of a virtual avatar, the computer-implemented method comprising providing a virtual avatar associated with a user, receiving an image of the user and at least a portion of their surroundings, applying a facial detection algorithm to detect the user's face in the image, extracting a region of interest from the image, the region of interest including the user's face, providing the region of interest to a data model, processing the region of interest, by the data model, and using feature recognition to determine whether the region of interest comprises a feature from a set of predefined features. In response to determining that the region of interest comprises a feature from a set of predefined features, the appearance of the virtual avatar is updated.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method for real-time customization of a virtual avatar, comprising:
providing a virtual avatar associated with a user;
receiving an image of the user and at least a portion of their surroundings;
applying a facial detection algorithm to detect the user's face in the image;
extracting a region of interest from the image, the region of interest including the user's face;
providing the region of interest to a data model;
processing the region of interest, by the data model, and using feature recognition to determine whether the region of interest comprises a feature from a set of predefined features; and
in response to determining that the region of interest comprises a feature from a set of predefined features, updating the appearance of the virtual avatar.

2. The computer-implemented method of claim 1, wherein the set of predefined features includes:
a plurality of facial features or body features; and/or
a plurality of accessories that may be worn on the user's face, head or body, optionally wherein the plurality of facial features or body features include one or more of:
hair colour; hair length; hair style; facial hair; ear type; nose type; eye type; tattoos; birthmarks; and/or skin tone.

3. The computer-implemented method of claim 2, wherein the plurality of accessories include one or more of:
eyewear; headwear; jewellery; clothes and/or other worn accessories.

4. The computer-implemented method of claim 1, wherein updating the appearance of the virtual avatar comprises applying the feature to the virtual avatar.

5. The computer-implemented method of claim 1, wherein updating the appearance of the virtual avatar comprises:
reviewing an image directory comprising a plurality of image elements to identify an image element that is representative of the feature; and
applying the image element to the virtual avatar.

6. The computer-implemented method of claim 5, wherein the image directory is associated with the virtual avatar.

7. The computer-implemented method of claim 5, wherein each feature of the set of predefined features has an associated label, and wherein each image element has an associated label, wherein reviewing the image directory to identify the image element that is representative of the feature comprises reviewing the image directory to identify the image element having a label that is the same as, or is closest to, or is associated with, the label of the feature.

8. The computer-implemented method of claim 1, wherein the region of interest is centred on the user's face and has a predefined area.

9. The computer-implemented method of claim 1, further comprising, prior to providing the region of interest to the data model:
scaling the region of interest to a predetermined size.

10. The computer-implemented method of claim 1, further comprising assigning, by the data model, a confidence value to the determined feature, wherein the appearance of the virtual avatar is only updated if the confidence value exceeds a predetermined threshold.

11. The computer-implemented method of claim 1, wherein applying the facial detection algorithm to detect the user's face in the image comprises identifying the user's face from a plurality of faces detected in the image.

12. The computer-implemented method of claim 1, further comprising:
receiving input audio data; and
providing at least a portion of the input audio data to the data model;
processing the input data by the data model to determine whether the input audio data comprises a feature from a set of predefined features, and in response to determining that the input data comprises a feature from a set of predefined features, updating the appearance of the virtual avatar.

13. The computer-implemented method of claim 12, wherein the input audio data comprises one or more of:
voice or vocal data;
environmental audio data; and
breathing audio data.

14. The computer-implemented method of claim 1, further comprising:
receiving input audio data;
processing the input audio data to determine whether the audio data includes music;
in response to determining that the audio data includes music, determining at least one property of the music; and
updating the appearance of the virtual avatar in response to the determined at least one property.

15. The computer-implemented method of claim 1, further comprising:
receiving input data identifying a music track that the user is listening to;
determining or receiving at least one property of the music track; and
updating the appearance of the virtual avatar in response to the determined at least one property.

16. The computer-implemented method of claim 14, wherein the at least one property includes one or more of:
a volume;
a tempo;
a genre;
an artist;
a play count;
a duration; and/or.

17. The computer-implemented method of claim 14, wherein updating the appearance of the virtual avatar in response to the determined at least one property comprises:
changing a colour or design of at least one accessory worn by the virtual avatar;
adding or removing at least one accessory worn by the virtual avatar; and/or
applying a skin from a plurality of predefined skins to the virtual avatar.

18. The computer-implemented method of claim 1, wherein the data model comprises an artificial neural network, ANN, optionally wherein the ANN comprises a convolutional neural network, CNN.

19. A system comprising one or more processors configured to implement the method as claimed in claim 1.

20. A non-transitory machine-readable medium having stored thereon a set of instructions, which if performed by one or more processors, cause the one or more processors to implement the method as claimed in claim 1.
